(19) United States
(12) Patent Application Publication
(10) Pub. No.: US 2015/0090029 A1
(43) Pub. Date: Apr. 2, 2015

(54) PHYSICAL QUANTITY SENSOR, PRESSURE SENSOR, ALTIMETER, ELECTRONIC APPARATUS, AND MOVING OBJECT

(71) Applicant: Seiko Epson Corporation, Tokyo (JP)

(72) Inventors: Kazuya HAYASHI, Fujimi (JP); Masahiro TAKEUCHI, Chino (JP)

(21) Appl. No.: 14/497,517

(22) Filed: Sep. 26, 2014

(30) Foreign Application Priority Data
Sep. 30, 2013 (JP) 2013-205752

(51) Int. Cl. G01L 7/08

(52) U.S. Cl. CPC G01L 7/08
USPC 73/386; 73/723

(57) ABSTRACT

A physical quantity sensor includes: a substrate that has a diaphragm section that is deformed to be deflected by receiving a pressure; a fixed electrode that is provided in the diaphragm section; and a movable electrode that has a movable section that is away from the fixed electrode and is disposed opposite to the fixed electrode, in which a shape of the diaphragm section in a plan view is a longitudinal shape extended in a predetermined direction, and in which a shape of the fixed electrode in a plan view is a longitudinal shape extending along a predetermined direction.

### BACKGROUND

1. Technical Field

The present invention relates to a physical quantity sensor, a pressure sensor, an altimeter, an electronic apparatus, and a moving object.

2. Related Art

In the related art, as a sensor detecting a pressure, a pressure detecting device is known as disclosed in JP-A-5-36993.

The pressure detecting device described in JP-A-5-36993 has a substrate that is a film shape and has a diaphragm deformable in a thickness direction, and a strain gauge that is disposed on the substrate. When a pressure is applied to the diaphragm, the diaphragm is deflected and a resistance value of the strain gauge changes in response to a deflection amount thereof. It is possible to detect the pressure applied to the diaphragm by detecting a potential difference generated due to a variation amount of the resistance value of a piezo-resistance element as a signal of a pressure change.

However, in the pressure detecting device having such a configuration, there is a problem that sensitivity is generally low.

### SUMMARY

An advantage of some aspects of the invention is to provide a physical quantity sensor having good sensitivity, a pressure sensor, an altimeter, an electronic apparatus, and a moving object.

The invention can be implemented as the following application examples.

### Application Example 1

This application example is directed to a physical quantity sensor including: a diaphragm section that is deformed to be deflected by receiving a pressure; a fixed electrode that is provided in the diaphragm section; and a movable electrode that has a movable section that is away from the fixed electrode and is disposed opposite to the fixed electrode, in which a shape of the diaphragm section in a plan view is a longitudinal shape, and in which a shape of the fixed electrode in a plan view is a longitudinal shape extending along a longitudinal direction of the diaphragm section.

With this configuration, it is possible to detect the pressure received by the diaphragm section with high accuracy and it is possible to provide the physical quantity sensor having good sensitivity.

### Application Example 2

In the physical quantity sensor according to the application example described above, it is preferable that the movable electrode has a support section that is provided in the diaphragm and a connection section that connects the support section and the movable section.

### Application Example 3

In the physical quantity sensor according to the application example described above, it is preferable that the fixed electrode and the support section are arranged along a lateral direction of the diaphragm section.

With this configuration, it is possible to specifically increase a variation amount of a gap between the fixed electrode and the movable electrode by deflection of the diaphragm section due to receiving of the pressure.

### Application Example 4

In the physical quantity sensor according to the application example described above, it is preferable that the lateral direction of the fixed electrode and the lateral direction of the diaphragm section are the same as each other.

With this configuration, it is possible to significantly increase the variation amount of the gap between the fixed electrode and the movable electrode by deflection of the diaphragm section due to receiving of the pressure.

### Application Example 5

In the physical quantity sensor according to the application example described above, it is preferable that the shape of the diaphragm section in a plan view is configured such that L2/L1 is within a range of 1.5 or more and 3.0 or less when a length in the longitudinal direction is L1 and a length in the lateral direction is L2.

With this configuration, when the diaphragm section is deformed to be deflected by receiving the pressure, it is possible to greatly change the gap (separation distance) between the fixed electrode and the movable electrode and thereby it is possible to further achieve improvement of accuracy of the physical quantity sensor.

### Application Example 6

This application example is directed to a pressure sensor including: the physical quantity sensor according to the application example described above.

With this configuration, it is possible to obtain the pressure sensor having high reliability.

### Application Example 7

This application example is directed to an altimeter including: the physical quantity sensor according to the application example described above.

With this configuration, it is possible to obtain the altimeter having high reliability.

### Application Example 8

This application example is directed to an electronic apparatus including: the physical quantity sensor according to the application example described above.

With this configuration, it is possible to obtain the electronic apparatus having high reliability.

### Application Example 9

This application example is directed to a moving object including: the physical quantity sensor according to the application example described above.

With this configuration, it is possible to obtain the moving object having high reliability.

### BRIEF DESCRIPTION OF THE DRAWINGS

The invention will be described with reference to the accompanying drawings, wherein like numbers reference like elements.

FIG. 1 is a cross-sectional view illustrating a first embodiment of a physical quantity sensor according to the invention.

FIGS. 2A and 2B are enlarged detailed views of a diaphragm section of the physical quantity sensor illustrated in FIG. 1, FIG. 2A is a cross-sectional view of a region “A” surrounded by a one-dotted chain line in FIG. 1, and FIG. 2B is a view that is viewed from a direction of arrow B in FIG. 2A.

FIGS. 3A and 3B are views illustrating modification of the diaphragm section illustrated in FIG. 1, FIG. 3A is a view illustrating a natural state, and FIG. 3B is a view illustrating a pressurized state.

FIGS. 4A and 4B are enlarged detailed views of the diaphragm section of the physical quantity sensor that is used for examination a relationship between a length of the diaphragm section in a longitudinal direction and a variation amount of a gap.

FIG. 5 is a graph illustrating the relationship between the length of the diaphragm section in the longitudinal direction and the variation amount of the gap.

FIGS. 6A to 6F are views illustrating a manufacturing process of the physical quantity sensor illustrated in FIG. 1.

FIGS. 7A to 7C are views illustrating the manufacturing process of the physical quantity sensor illustrated in FIG. 1.

FIGS. 8A to 8C are views illustrating the manufacturing process of the physical quantity sensor illustrated in FIG. 1.

FIGS. 9A and 9B are views illustrating the manufacturing process of the physical quantity sensor illustrated in FIG. 1.

FIGS. 10A and 10B are enlarged cross-sectional views illustrating a second embodiment of a physical quantity sensor according to the invention, FIG. 10A is an enlarged cross-sectional view, and FIG. 10B is a view that is viewed from a direction of arrow D in FIG. 10A.

FIGS. 11A and 11B are views illustrating deformation of the diaphragm section illustrated in FIGS. 10A and 10B, FIG. 11A is a view illustrating a natural state, and FIG. 11B is a view illustrating a pressurized state.

FIG. 12 is a graph illustrating a relationship between a distance between an end of the support section and a center of the diaphragm section and the variation amount of the gap.

FIG. 13 is a cross-sectional view illustrating an example of a pressure sensor according to the invention.

FIG. 14 is a perspective view illustrating an example of an altimeter according to the invention.

FIG. 15 is a front view illustrating an example of an electronic apparatus according to the invention.

FIG. 16 is a perspective view illustrating an example of a moving object according to the invention.

### DESCRIPTION OF EXEMPLARY EMBODIMENTS

Hereinafter, a physical quantity sensor, a pressure sensor, an altimeter, an electronic apparatus, and a moving object according to the invention will be described with reference to each embodiment illustrated in the drawings.

### First Embodiment

### 1. Physical Quantity Sensor

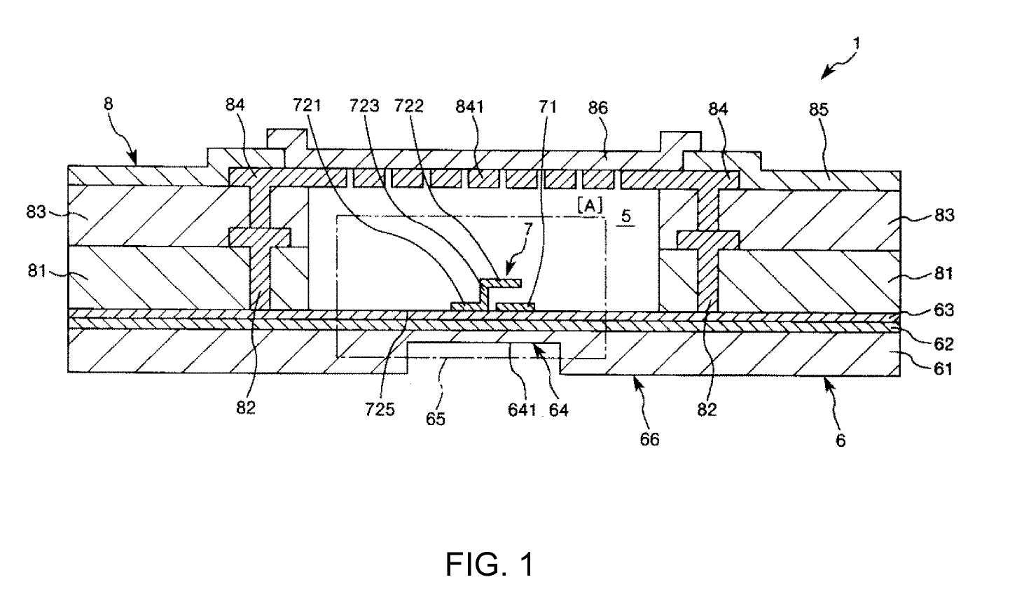

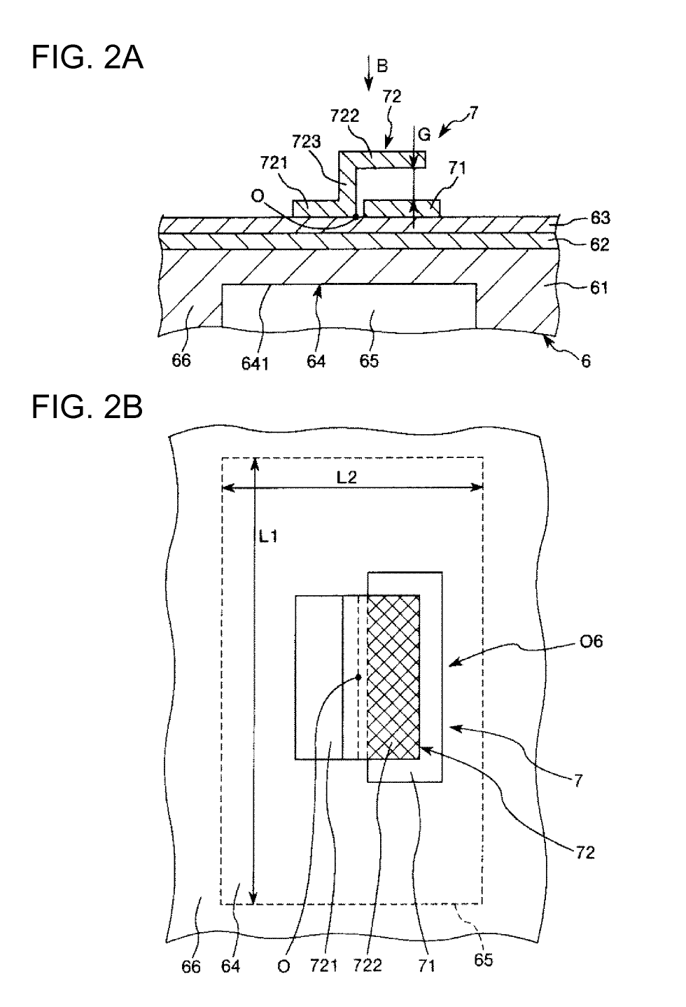

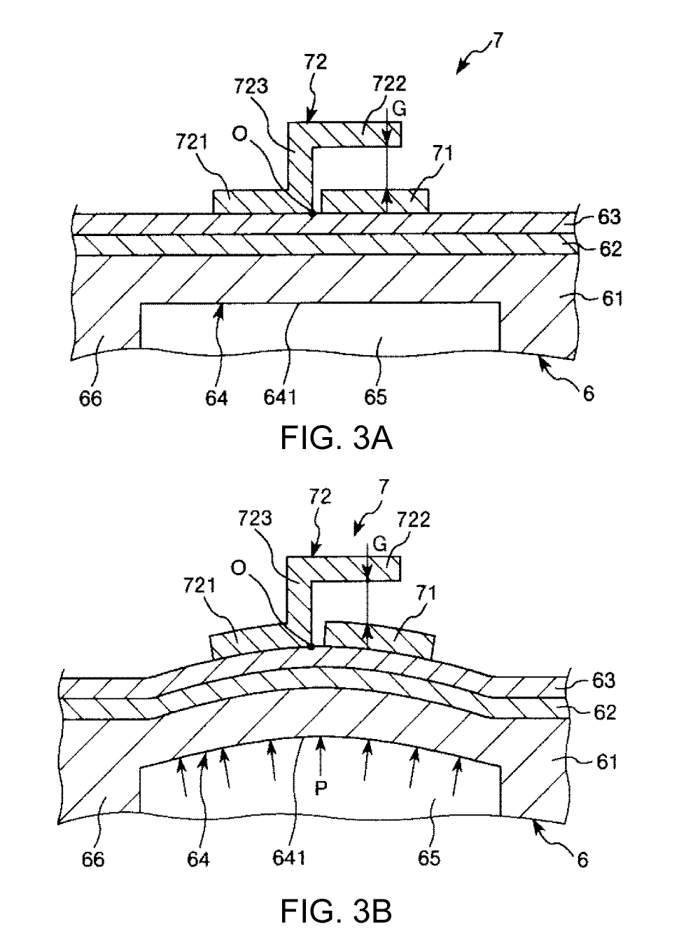

FIG. 1 is cross-sectional view illustrating a first embodiment of a physical quantity sensor according to the invention. FIGS. 2A and 2B are enlarged detailed views of a diaphragm section of the physical quantity sensor illustrated in FIG. 1, FIG. 2A is a cross-sectional view of a region A surrounded by a one-dotted chain line in FIG. 1, and FIG. 2B is a view that is viewed from a direction of arrow B in FIG. 1A. FIGS. 3A and 3B are views illustrating deformation of the diaphragm section illustrated in FIG. 1, FIG. 3A is a view illustrating a natural state, and FIG. 3B is a view illustrating a pressurized state.

A physical quantity sensor 1 of FIG. 1 has a substrate 6, a functional element 7, an element ambient structure 8, a cavity section 5, and a semiconductor circuit (not illustrated). Hereinafter, each section is sequentially described below.

### Substrate 6

A substrate 6 is formed as a planar shape and, for example, can be configured by laminating an insulation film 62 and a silicon nitride film 63 in this order on a semiconductor substrate 61 configured of a semiconductor such as silicon. A shape of such a substrate 6 in a plan view is not specifically limited and, for example, can be rectangular such as substantially square and substantially rectangular or circular.

Furthermore, the substrate 6 is provided with a diaphragm section 64 that is thinner than peripheral portions and is deformed to be deflected by receiving pressure. The diaphragm section 64 is formed by providing a concave section 65 having a bottom on a lower surface of the substrate 6. Such a diaphragm section 64 is substantially rectangular in a plan view and a lower surface thereof is a pressure receiving surface 641. A thickness of the diaphragm section 64 is not specifically limited and, for example, is preferably 10 μm or more and 50 μm or less, and is further preferably 15 μm or more and 25 μm or less. Therefore, the diaphragm section 64 can be sufficiently deflected to be deformed.

Moreover, in the substrate 6 of the embodiment, the concave section 65 does not pass through the semiconductor substrate 61 and the diaphragm section 64 is configured of three layers of the semiconductor substrate 61, the insulation film 62, and the silicon nitride film 63, but, for example, the concave section 65 may pass through the semiconductor substrate 61 and the diaphragm section 64 may be configured of two layers of the insulation film 62 and the silicon nitride film 63.

### Functional Element 7

A functional element 7 has a fixed electrode 71 and a movable electrode 72 provided on the diaphragm section 64 of the substrate 6. Furthermore, the movable electrode 72 has a support section 721, a movable section 722 that is disposed opposite to the fixed electrode 71 with a space therebetween, and an elastically deformable connection section 723 that connects the support section 721 and the movable section 722 on the substrate 6.

Furthermore, a film thickness of the fixed electrode 71 is not specifically limited, but can be 0.1 μm or more and 1.0 μm or less. Furthermore, a film thickness of the movable electrode 72 is not specifically limited, but can be 0.1 μm or more and 1.0 μm or less.

### Element Ambient Structure 8

An element ambient structure 8 is formed to define the cavity section 5 in which the functional element 7 is disposed. The element ambient structure 8 having such a configuration includes an interlayer insulation film 81 that is formed so as to surround the functional element 7 on the substrate 6, a wiring layer 82 that is formed on the interlayer insulation film 81, an interlayer insulation film 83 that is formed on the wiring layer 82 and the interlayer insulation film 81, a wiring layer 84 that is formed on the interlayer insulation film 83 and has a coating layer 841 including a plurality of fine holes (openings), a surface protection film 85 that is formed on the wiring layer 84 and the interlayer insulation film 83, and a sealing layer 86 that is formed on the coating layer 841.

A semiconductor circuit (not illustrated) is built into the semiconductor substrate 61 and above thereof. The semiconductor circuit has a circuit element such as an active element such as a MOS transistor and a circuit element such as a capacitor, an inductor, a resistor, a diode, wiring (including wiring connected to the fixed electrode 71, wiring connected to the movable electrode 72, the wiring layers 82 and 84), and the like which are formed if necessary.

### Cavity Section 5

The cavity section 5 defined by the substrate 6 and the element ambient structure 8 functions as a storage section for storing the functional element 7. Furthermore, the cavity section 5 is a space that is sealed. The cavity section 5 functions as a pressure reference chamber that is a reference value of a pressure that is detected by the physical quantity sensor 1. In the embodiment, the cavity section 5 is in a vacuum state (300 Pa or less). It is possible to use the physical quantity sensor 1 as an “absolute pressure sensor” detecting the pressure with reference to the vacuum state and to improve convenience by making the cavity section 5 have the vacuum state.

However, the cavity section 5 may not be in the vacuum state and may be at atmospheric pressure and may be in a reduced pressure state that is lower than atmospheric pressure, and may be a pressurized state that is higher than atmospheric pressure.

As described above, the configuration of the physical quantity sensor 1 is briefly described. As illustrated in FIGS. 3A and 3B, the physical quantity sensor 1 deforms the diaphragm section 64 depending on the pressure received by the pressure receiving surface 641 of the diaphragm section 64 and thereby a gap (separation distance) G between the movable section 722 of the movable electrode 72 and the fixed electrode 71 is changed. When the gap G is changed, since a resonance frequency of a resonance system configured of the fixed electrode 71 and the movable electrode 72 is changed, it is possible to obtain a value for the pressure (absolute pressure) received by the pressure receiving surface 641 from the change of the resonance frequency.

As described above, the physical quantity sensor 1 is configured such that since the cavity section 5 is in the vacuum state, if a pressure P is applied to the pressure receiving surface 641, the diaphragm section 64 is deformed to be deflected on the side of the cavity section 5. Moreover, in FIG. 3A, the diaphragm section 64 and a thick section 66 form a straight line, but the diaphragm section 64 is slightly deflected so as to protrude to the side (upper side in FIGS. 3A and 3B) of the cavity section 5 at atmospheric pressure.

In the physical quantity sensor 1, the arrangement of the functional element 7 or the shape of the diaphragm section 64 is featured so as to detect the received pressure with high accuracy. Hereinafter, detailed description will be given regarding this.

As illustrated in FIGS. 2A and 2B, the functional element 7 is positioned in a center portion of the diaphragm section 64. Furthermore, the fixed electrode 71 and the support section 721 are arranged along a lateral direction of the diaphragm section 64. That is, the arrangement direction of the fixed electrode 71 and the support section 721 is parallel to the arrangement direction of the diaphragm section 64. An end 725 of the support section 721 on the side of the fixed electrode 71 is positioned in a center (intersecting point of diagonal lines) O of the diaphragm section 64. Furthermore, the fixed electrode 71 is positioned on the right side of the support section 721 in FIGS. 2A and 2B.

Furthermore, a shape of the diaphragm section 64 in a plan view is rectangular. Furthermore, respective shapes of the fixed electrode 71 and the movable section 722 in a plan view are rectangular extending along the longitudinal direction of the diaphragm section 64. A leading end portion (free end portion) of the movable section 722 is included in the fixed electrode 71 in a plan view. The lateral direction of the fixed electrode 71 and the lateral direction of the movable section 722 are parallel to the lateral direction of the diaphragm section 64. Thus, naturally, the longitudinal direction of the fixed electrode 71 and the longitudinal direction of the movable section 722 are parallel to the longitudinal direction of the diaphragm section 64.

As described above, since the end 725 of the support section 721 is provided on the center O and the fixed electrode 71 is provided on the side of the thick section 66 more than the support section 721, when the diaphragm section 64 is deflected, the gap G increases.

Furthermore, as described above, since the fixed electrode 71 and the support section 721 are arranged along the lateral direction of the diaphragm section 64, a difference in a displacement amount between the support section 721 and the fixed electrode 71 when the diaphragm section 64 is deflected can be further increased. This is because the side of the lateral direction of the diaphragm section 64 is displaced at a steep angle with respect to the substrate 6 more than the side of the longitudinal direction of the diaphragm section 64 when the diaphragm section 64 is deformed to be deflected.

Specifically, the lateral direction of the fixed electrode 71 and the lateral direction of the support section 721 are parallel to the lateral direction of the diaphragm section 64. That is, since the lateral direction of the fixed electrode 71 and the lateral direction of the diaphragm section 64 are the same direction as each other, the effects described above are remarkably exerted.

Moreover, for example, “parallel” includes that the lateral direction of the fixed electrode 71 and the lateral direction of the support section 721 are inclined by substantially 2 degrees to 3 degrees with respect to the lateral direction of the diaphragm section 64 in addition to being completely parallel to each other.

Furthermore, in the embodiment, the shape of the diaphragm section 64 is rectangular, but if the diaphragm section 64 is a longitudinal shape other than rectangular, when the arrangement direction of the fixed electrode 71 and the support section 721 is parallel to a direction straight to the direction in which the diaphragm section 64 is extended, it is possible to obtain the same effects as described above.

Furthermore, a center portion O6, specifically, the center O in which the functional element 7 is provided is a greatly deflected portion when the pressure is applied. Thus, since the support section 721 can be greatly displaced, it is possible to further increase the variation amount of the gap (variation amount of the separation distance G).

Furthermore, the center portion O6, specifically, the center O of the diaphragm section 64 tends to be greatly deflected as a length L1 of the diaphragm section 64 in the longitudinal direction is long with respect to a length L2 in the lateral direction. Therefore, it is possible to further increase the variation amount of the gap by further lengthening the length L1 with respect to the length L2 and thereby it is possible to obtain the physical quantity sensor 1 having good sensitivity.

A relationship between the length L2 of the diaphragm section 64 in the lateral direction and the length L1 in the longitudinal direction is not specifically limited, but L1/L2 is preferably 1.5 or more and 3.0 or less, and further preferably 1.7 or more and 2.8 or less, and still further preferably 1.8 or more and 2.5 or less. Therefore, it is possible to specifically increase the variation amount of the gap and it is possible to achieve both reduction in size and high sensitivity of the physical quantity sensor 1. Moreover, in the embodiment, L1/L2 is substantially 2.0.

Furthermore, the length L1 of the diaphragm section 64 in the longitudinal direction is preferably 50 μm or more and 110 μm or less and the length L2 of the diaphragm section 64 in the lateral direction is not specifically limited, but is preferably 10 μm or more and 70 μm or less.

An area S1 of the fixed electrode 71 in a plan view is not specifically limited, but is preferably 100 μm² or more and 800 μm² or less. Furthermore, an area S5 of the diaphragm section 64 in a plan view is not specifically limited, but is preferably 1000 μm² or more and 7000 μm² or less. Therefore, it is possible to achieve the reduction in size of the physical quantity sensor 1.

Furthermore, the gap G between the movable section 722 and the fixed electrode 71 is preferably 0.3 μm or more and 1.0 μm or less in a state where the diaphragm section 64 is not deformed to be deflected. Therefore, it is possible to further effectively actuate the functional element 7 and it is possible to deflect the diaphragm section 64, and it is possible to avoid the contact between the fixed electrode 71 and the movable section 722. Thus, it is possible to prevent damage to the fixed electrode 71 and the movable section 722.

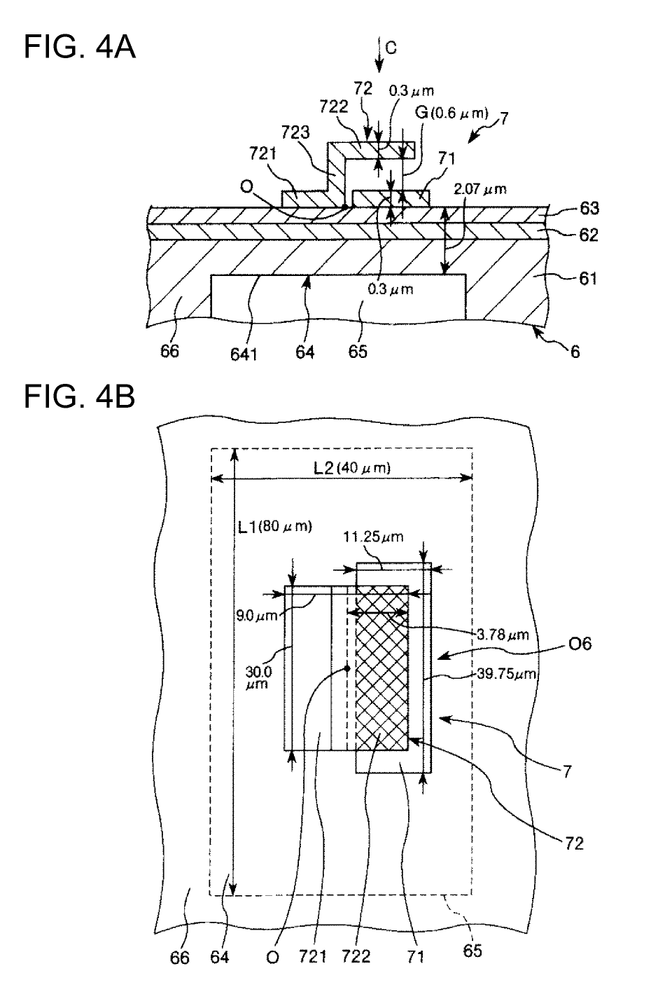

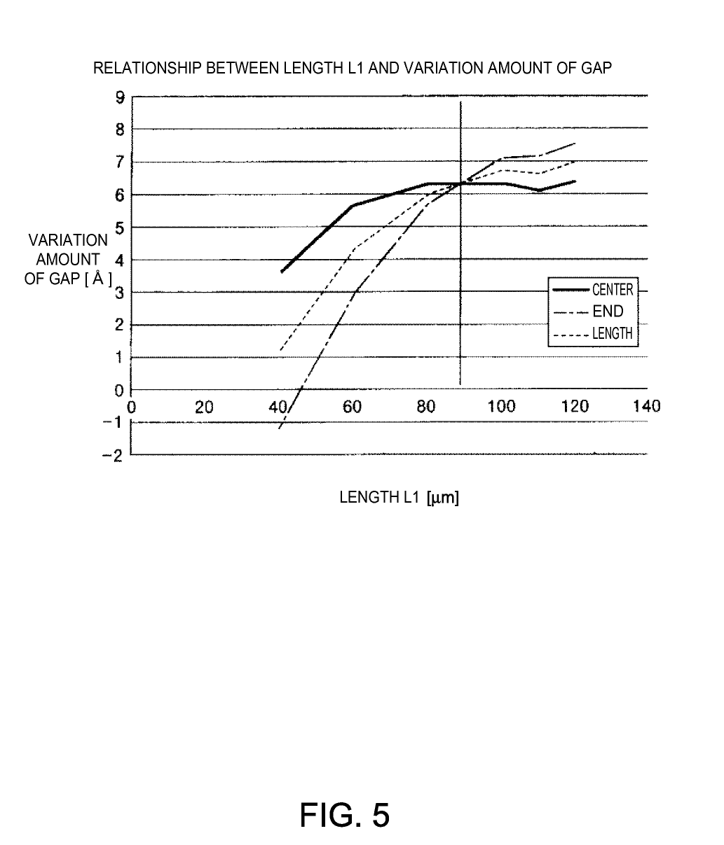

Hereinafter, examination results for the variation amount of the gap with respect to the length L1 of the diaphragm section 64 in the longitudinal direction are described with reference to FIGS. 4A, 4B, and 5.

FIGS. 4A and 4B are enlarged detailed views of the physical quantity sensor 1 used for examination of the relationship between the length L1 of the diaphragm section 64 in the longitudinal direction and the variation amount of the gap. Moreover, FIG. 4A is an enlarged detailed cross-sectional view of the diaphragm section 64 of the physical quantity sensor 1 and FIG. 4B is a view that is viewed from a direction of arrow C in FIG. 4A. Furthermore, FIG. 5 is a graph illustrating the relationship between the length L1 of the diaphragm section 64 in the longitudinal direction and the variation amount of the gap.

A horizontal axis of the graph illustrated in FIG. 5 indicates the length L1 and a vertical axis indicates the variation amount of the gap. Moreover, the variation amount of the gap indicates a value obtained by subtracting the gap G of the natural state (state where the same pressure as that of the cavity section 5 is applied) from the gap G in the pressurized state. Furthermore, “AVE” indicates an average value of the variation amount of the gap in a region X (see FIG. 4B) in which the fixed electrode 71 and the movable section 722 are overlapped in a plan view and “center” indicates the variation amount of the gap in an end on the side of the center O in the region X, and “end” indicates the variation amount of the gap in the end on the opposite side to the center O in the region X.

Dimensions of each section of the physical quantity sensor 1 used for the examination are as follows.

The length L1 of the diaphragm section 64 in the longitudinal direction is 80 μm, the length L2 in the lateral direction is 40 μm, and the film thickness of the diaphragm section 64 is 2.07 μm. Furthermore, the length of the fixed electrode 71 in the longitudinal direction is 39.75 μm and the length in the lateral direction is 11.25 μm. Furthermore, the length of the movable electrode 72 in the longitudinal direction is 30.0 μm and the length in the lateral direction is 9.0 μm. Furthermore, the length of the movable section 722 in the lateral direction is 3.78 μm. Furthermore, in the natural state, the gap G between the movable section 722 and the fixed electrode 71 is 0.6 μm. Furthermore, each film thickness of the fixed electrode 71 and the movable electrode 72 is 0.3 μm.

Furthermore, the functional element 7 was provided so that the end 725 of the support section 721 was positioned on the center O of the diaphragm section 64. Furthermore, the pressure applied to the diaphragm section 64 was 100 kPa.

Furthermore, as an examination method, an detection method was used in which the position of the functional element 7 was not changed and the length L1 of the diaphragm section 64 in the longitudinal direction was changed, and the variation amount of the gap was detected for each length L1.

It was found that the variation amount of the gap was increased as the length L1 was long from the graph illustrated in FIG. 5.

Furthermore, if the length L1 is longer than 60 μm, it was found that the variation amount of the gap was specifically increased. The length L1 (60 μm) was 1.5×L2 or more in terms of the relationship with the length L2 of the diaphragm section 64 in the lateral direction.

Furthermore, if the length L1 is substantially 120 μm, great change cannot be seen in the variation amount of the gap. The length L1 (120 μm) was 3.0×L2 in terms of the relationship with the length L2 of the diaphragm section 64 in the lateral direction.

As described above, the length L1 satisfied a numerical value range (1.5×L2 or more and 3.0 L×2 or less) as described above, in the relationship with the length L2 and thereby it was found that it is possible to sufficiently achieve both the reduction in size and the high sensitivity.

Furthermore, the sensitivity when the length L1 was 40 μm and the sensitivity when the length L1 was 80 μm were calculated respectively based on the measured variation amount of the gap.

The sensitivity when the length L1 was 40 μm was 3.29 ppm/kPa. Furthermore, the sensitivity when the length L1 was 80 μm was 8.49 ppm/kPa. It was found that it is possible to improve the sensitivity of the physical quantity sensor 1 by forming the diaphragm section 64 in the longitudinal shape extending in the longitudinal direction.

Next, a manufacturing method of the physical quantity sensor 1 will be briefly described.

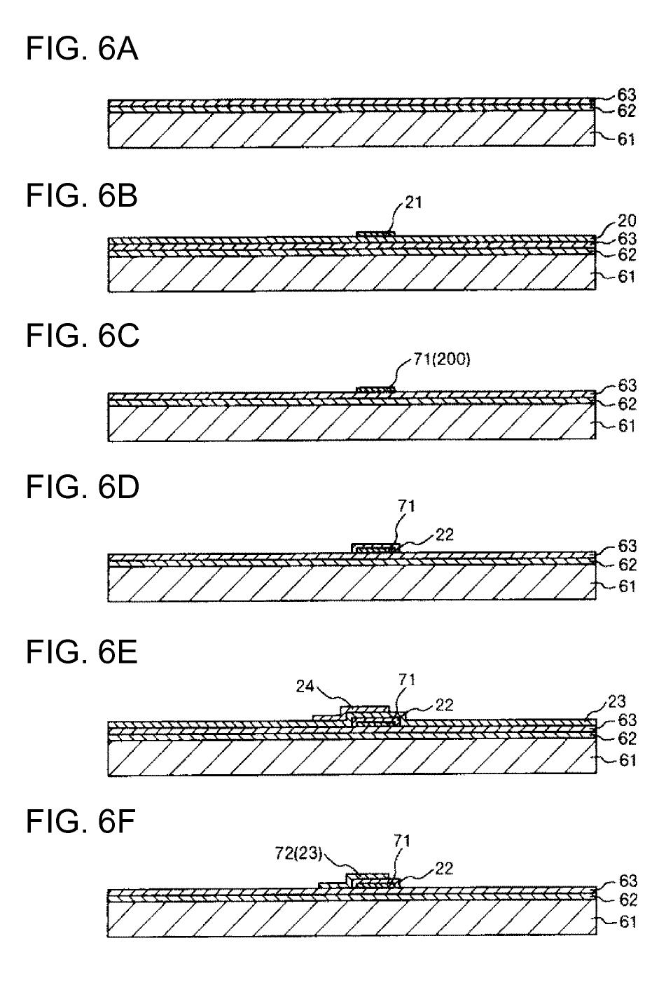

FIGS. 6A to 9B are views illustrating the manufacturing process of the physical quantity sensor. Hereinafter, the description thereof will be given with reference to the drawings.

### Functional Element Forming Process

First, as illustrated in FIG. 6A, the semiconductor substrate 61 of a silicon substrate and the like is prepared. Next, the silicon oxide film (insulation film) 62 is formed by thermally oxidizing the upper surface of the prepared semiconductor substrate 61 and a silicon nitride film 63 is formed on the silicon oxide film 62 by a sputtering method, a CVD method, and the like. Thus, a substrate member 6A is obtained.

The silicon oxide film 62 functions as an inter-element isolation film when forming the semiconductor substrate 61 and a semiconductor circuit above thereof. Furthermore, the silicon nitride film 63 has durability with respect to etching that is performed in a release process that is performed thereafter and functions as a so-called etching-stop layer. Moreover, the silicon nitride film 63 is formed on a limited range including a plane range in which the functional element 7 is formed by the patterning process and a range of a part of element (capacitor) and the like inside the semiconductor circuit. Therefore, failure is eliminated when forming the semiconductor substrate 61 and the semiconductor circuit above thereof.

Next, as illustrated in FIG. 6B, a polycrystalline (or amorphous) silicon film 20 for forming the fixed electrode 71 is formed on the silicon nitride film 63 by a sputtering method, a CVD method, and the like, and conductivity is provided by doping impurity ions such as phosphorus ions in the polycrystalline (or amorphous) silicon film 20. Then, a photoresist is applied to the polycrystalline (or amorphous) silicon film 20 and patterning is performed to the shape (shape in a plan view) of the fixed electrode 71 and then a patterned photoresist film 21 is formed.

Next, as illustrated in FIG. 6C, the polycrystalline (or amorphous) silicon film 20 is etched by masking the photoresist film 21 that is patterned and then the photoresist film 21 is removed. Therefore, the fixed electrode 71 is formed.

Next, as illustrated in FIG. 6D, a sacrifice layer 22 formed of a silicon oxide film or a phosphorus-doped glass (PSG) is formed by a thermal oxidation method, the sputtering method, a CVD method, and the like so as to cover the fixed electrode 71.

Next, as illustrated in FIG. 6E, a polycrystalline (or amorphous) silicon film 23 is formed on the silicon nitride film 63 and the sacrifice layer 22 by a sputtering method, a CVD method, and the like to form the movable electrode 72, and a conductivity is provided by doping the impurity ions such as phosphorus ions in the formed polycrystalline (or amorphous) silicon film 23. Then, the photoresist is applied on the polycrystalline (or amorphous) silicon film 23 and a patterned photoresist film 24 that is patterned in the shape (shape in a plan view) of the movable electrode 72 is formed.

Next, as illustrated in FIG. 6F, after the polycrystalline (or amorphous) silicon film 23 is etched by masking the photoresist film 24, the photoresist film 24 is removed. Therefore, the movable electrode 72 is formed and the functional element 7 having the fixed electrode 71 and the movable electrode 72 is formed.

### Insulation Film Forming Process

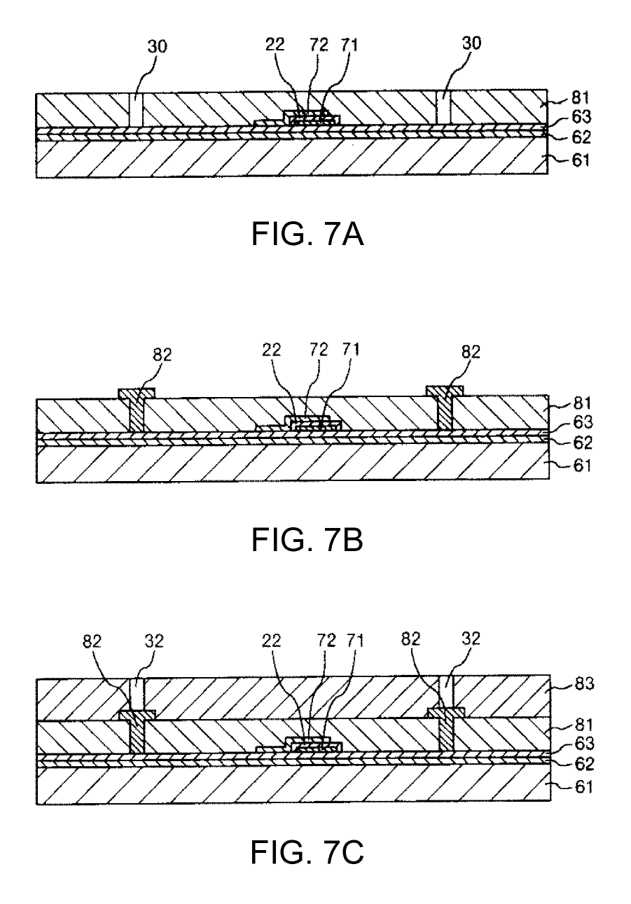

First, as illustrated in FIG. 7A, the interlayer insulation film 81 formed of the silicon oxide film is formed on the silicon nitride film 63 and the functional element 7 by a sputtering method, a CVD method, and the like. Furthermore, a circular opening section 30 surrounding the functional element 7 in the semiconductor substrate 61 in a plan view is formed in the interlayer insulation film 81 by a patterning process and the like.

Next, as illustrated in FIG. 7B, for example, after a layer formed of aluminum is formed on the interlayer insulation film 81 by a sputtering method, a CVD method, and the like, the wiring layer 82 is formed by a patterning process. The wiring layer 82 is circular in a plan view of the semiconductor substrate 61 so as to correspond to the opening section 30. Furthermore, a part of the wiring layer 82 is electrically connected to the semiconductor substrate 61 and wiring (for example, wiring configuring a part of the semiconductor circuit (not illustrated)) formed above thereof through the opening section 30. Moreover, the wiring layer 82 is formed so as to exist only in the portion in which the silicon nitride film 63 and the functional element 7 are surrounded, but generally, a part of the wiring layer that configures a part of the semiconductor circuit (not illustrated) configures the wiring layer 82.

Next, as illustrated in FIG. 7C, the interlayer insulation film 83 formed of the silicon oxide film and the like is formed on the interlayer insulation film 81 and the wiring layer 82 by a sputtering method, a CVD method, and the like. Furthermore, a circular opening section 32 surrounding the silicon nitride film 63 and the functional element 7 in a plan view of the semiconductor substrate 61 is formed on the interlayer insulation film 81 by a patterning process and the like. Moreover, the opening section 32 may not be circular in a plan view of the semiconductor substrate 61 similar to the opening section 30 and a part thereof may be deleted.

A laminated structure of the interlayer insulation film and the wiring layer is formed by a usual CMOS process and the number of the lamination is appropriately set if necessary. That is, more wiring layers may be laminated through the interlayer insulation film if necessary.

### Coating Layer Forming Process

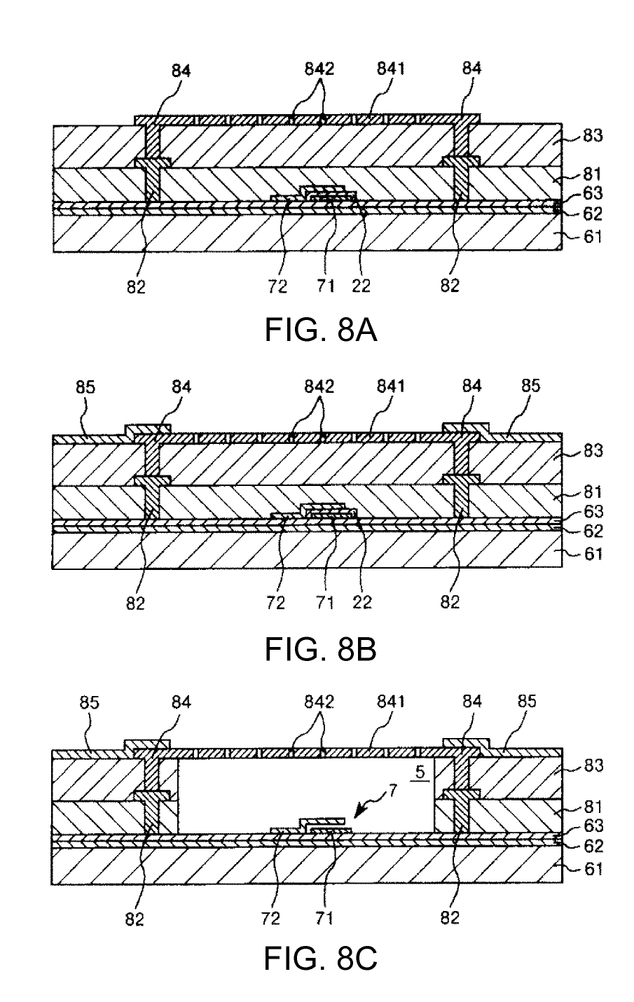

First, as illustrated in FIG. 8A, for example, after a layer formed of aluminum is formed on the interlayer insulation film 83 by a sputtering method, a CVD method, and the like, the wiring layer 84 is formed by a patterning process. Apart of the wiring layer 84 is electrically connected to the wiring layer 82 through the opening section 32. Furthermore, a part of the wiring layer 84 is positioned above the silicon nitride film 63 and the functional element 7, and configures the coating layer 841 in which a plurality of fine holes 842 are formed. The wiring layer 84 is generally configured of a part of the wiring layer configuring a part of the semiconductor circuit (not illustrated) similar to the wiring layer 82 described above.

Next, as illustrated in FIG. 8B, for example, the surface protection film 85 formed of a silicon nitride film, a resist, a resin material and the like is formed on the wiring layer 84 and the interlayer insulation film 83 by a sputtering method, a CVD method, and the like. Furthermore, the surface protection film 85 is configured of a plurality of film layers including a material of one or more types and is formed so as not to seal the fine holes 842 of the coating layer 841. Moreover, as a configuration material of the surface protection film 85, a material having durability such as a silicon oxide film, a silicon nitride film, a polyimide film, and an epoxy resin film is formed for protecting the element from moisture, dust, scratching, and the like.

### Release Process

First, as illustrated in FIG. 8C, after the protective film forming process of the photoresist and the like for release etching is performed, the interlayer insulation films 81 and 83 on the functional element 7 are removed through the plurality of fine holes 842 formed in the coating layer 841, and the sacrifice layer 22 between the fixed electrode 71 and the movable section 722 is removed. Therefore, the cavity section 5 in which the functional element 7 is disposed is formed and the fixed electrode 71 and the movable section 722 are separated from each other, and the functional element 7 may be driven.

Removing of the interlayer insulation films 81 and 83, and the sacrifice layer 22 can be performed by wet etching in which hydrofluoric acid, buffered hydrofluoric acid, and the like as etching solution are supplied from the plurality of fine holes 842, or by dry etching in which hydrofluoric acid gas and the like as etching gas are supplied from the plurality of fine holes 842.

### Sealing Process

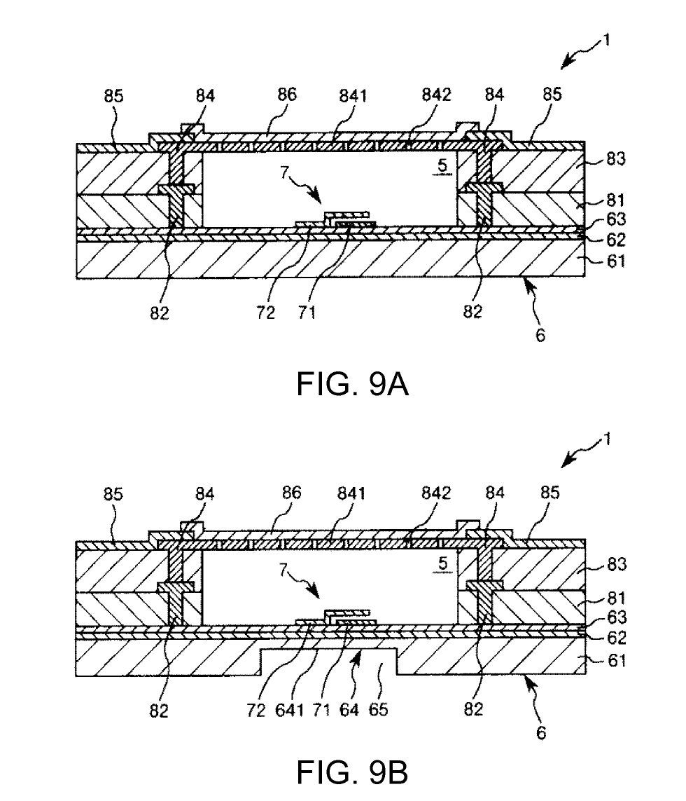

Next, as illustrated in FIG. 9A, the sealing layer 86 formed of a silicon oxide film, a silicon nitride film, a metal film of AL, Cu, W, Ti, TiN, and the like is formed on the coating layer 841 by a sputtering method, a CVD method, and the like to seal the fine holes 842.

### Diaphragm Forming Process

Finally, as illustrated in FIG. 9B, for example, dry etching is performed from a surface of the semiconductor substrate 61 opposite to the cavity section 5 and a part of the semiconductor substrate 61 is removed. Therefore, the diaphragm section 64 that is thinner than the surroundings is formed. Furthermore, a portion of the semiconductor substrate 61 other than the diaphragm section 64 is the thick section 66.

Moreover, a method for removing a part of the semiconductor substrate 61 is not limited to the dry etching and may be wet etching and the like.

It is possible to manufacture the physical quantity sensor 1 by the processes described above. Moreover, a circuit element such as an active element, a capacitor, an inductor, a resistor, a diode, and wiring of the MOS transistor included in the semiconductor circuit of the physical quantity sensor 1 may be made in the middle of an appropriate process described above (for example, the functional element forming process, the insulation film forming process, the coating layer forming process, and the sealing layer forming process). For example, an inter-circuit element isolation film may be formed together with the silicon oxide film 62, a gate electrode, a capacitor electrode, wiring, and the like may be formed together with the fixed electrode 71 or the movable electrode 72, a gate insulation film, a capacitor dielectric layer, and an interlayer insulation film, may be formed together with the sacrifice layer 22 and the interlayer insulation films 81 and 83, or circuit wiring may be formed together with the wiring layers 82 and 84.

### Second Embodiment

Next, a second embodiment of a physical quantity sensor according to the invention will be described.

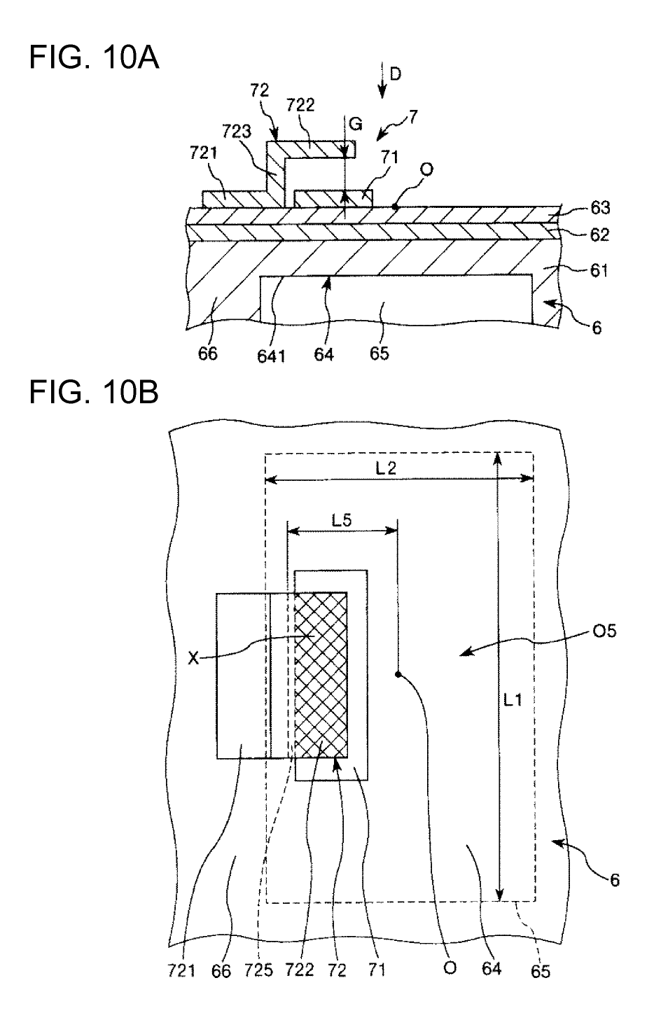

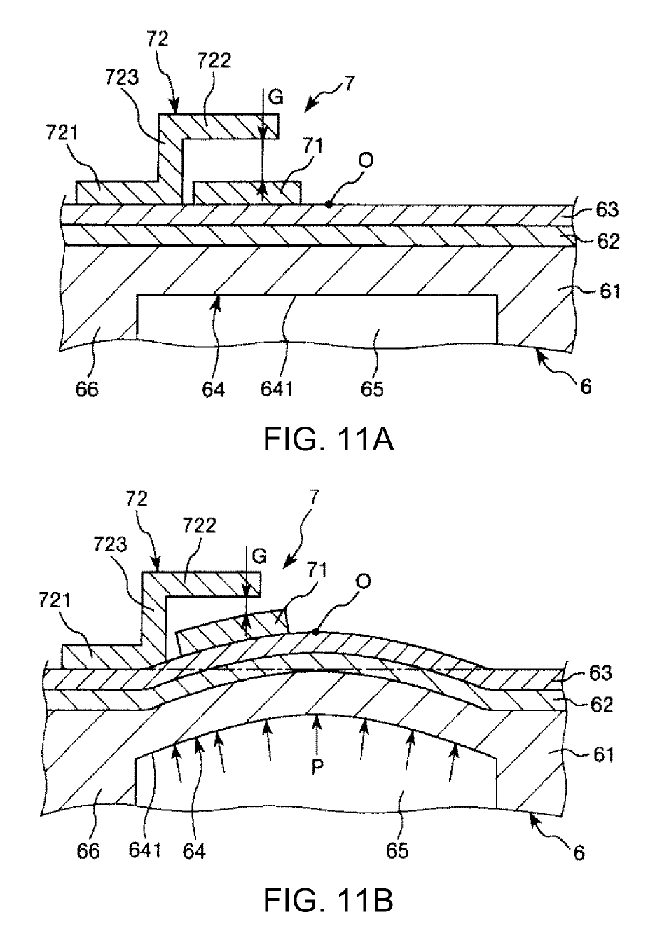

FIGS. 10A and 10B are enlarged cross-sectional views illustrating the second embodiment of the physical quantity sensor according to the invention, FIG. 10A is an enlarged cross-sectional view, and FIG. 10B is a view that is viewed from a direction of arrow D in FIG. 10A. FIGS. 11A and 11B are views illustrating a deformation of the diaphragm section illustrated in FIGS. 10A and 10B, FIG. 11A is a view illustrating a natural state, and FIG. 11B is a view illustrating a pressurized state.

Hereinafter, the second embodiment of the physical quantity sensor according to the invention will be described with reference to the drawings and will be described focusing on differences from the embodiment described above and the description of the same matters will be omitted.

The second embodiment is similar to the first embodiment other than that the position of the functional element 7 is different.

As illustrated in FIGS. 10A and 10B, the functional element 7 is biased to the left side in FIGS. 2A and 2B from the center (intersecting point of diagonal lines) O of the diaphragm section 64. The fixed electrode 71 is positioned between the support section 721 and the center O of the diaphragm section 64. The fixed electrode 71 is provided in the region of the diaphragm section 64 and the support section 721 is provided over the diaphragm section 64 and the thick section 66.

Similar to the first embodiment, the fixed electrode 71 is displaced on the side of the cavity section 5 following the deflection of the diaphragm section 64 by providing the fixed electrode 71 on the diaphragm section 64. On the other hand, since a part of the movable electrode 72 is provided in the thick section 66, the movable electrode 72 is suppressed from displacing to the cavity section 5 more than the fixed electrode 71. Therefore, as illustrated in FIGS. 11A and 11B, when the diaphragm section 64 is deflected, the gap G decreases.

Furthermore, a distance L5 between the center O of the diaphragm section 64 and the end 725 of the support section 721 on the side of the fixed electrode 71 with respect to the length L2 of the diaphragm section 64 in the lateral direction is preferably 0.43×L2 or more and 0.4875×L2 or less and further preferably 0.44×L2 or more and 0.47×L2 or less, and still further preferably 0.45×L2 or more and 0.465×L2 or less. It is possible to specifically increase the variation amount of the gap G by providing the support section 721 in a position satisfying the range described above. Thus, it is possible to obtain the physical quantity sensor 1 having specifically good sensitivity.

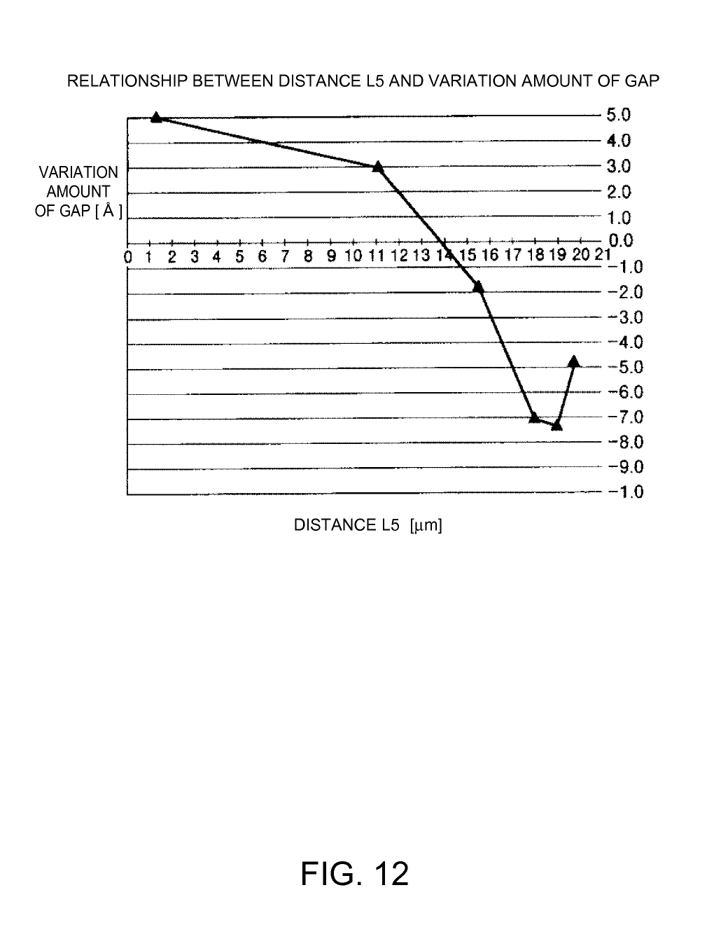

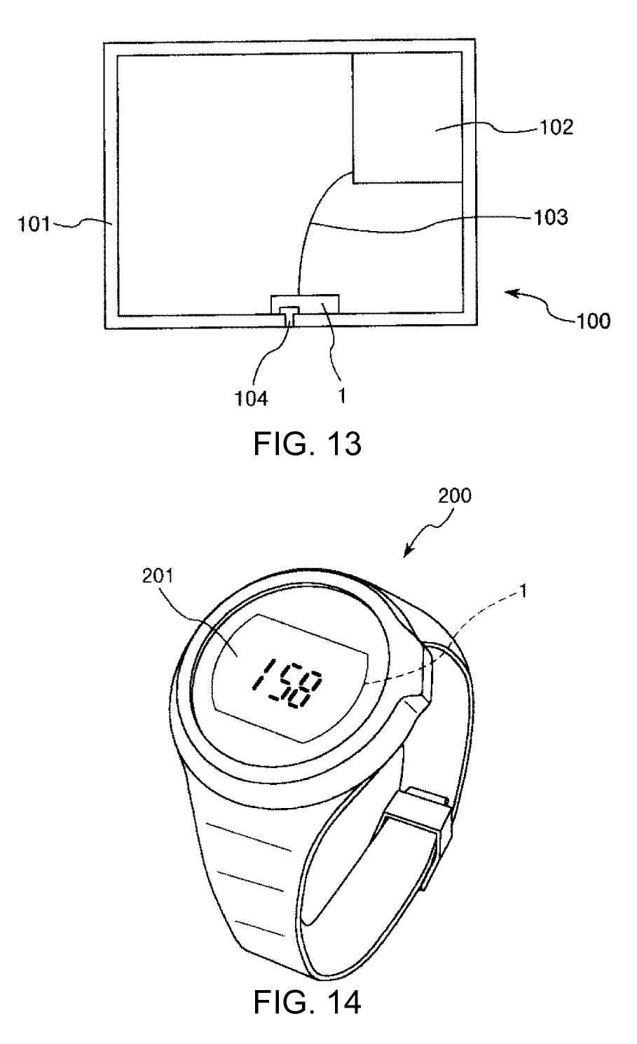

Hereinafter, examination results of the variation amount of the gap with respect to the distance L5 are described with reference to FIG. 12.

FIG. 12 is a graph illustrating a relationship between the distance L5 between the end 725 of the support section 721 and the center O of the diaphragm section 64 and the variation amount of the gap.

A horizontal axis of the graph illustrated in FIG. 12 indicates the distance L5 and a vertical axis indicates the variation amount of the gap. Moreover, the variation amount of the gap indicates a value obtained by subtracting minus the gap G of the natural state (state where the same pressure as that of the cavity section 5 is applied) from the gap G in the pressurized state.

Furthermore, the graph indicates an average value of the variation amount of the gap in a region X (see FIG. 10B) in which the fixed electrode 71 and the movable section 722 are overlapped in a plan view.

Moreover, the dimensions of each section of the physical quantity sensor 1 used for examination are the same as those of the first embodiment.

Furthermore, as an examination method, a method was used in which the separation distance between the fixed electrode 71 and the support section 721 was not changed and the distance L5 was changed by moving the functional element 7 in the lateral direction of the diaphragm section 64, and the variation amount of the gap was detected for each distance L5. Moreover, a pressure applied to the diaphragm section 64 was 100 kPa.

It was found that the absolute value of the variation amount of the gap was specifically increased when the distance L5 was 17.5 μm or more and 19.5 μm or less from the graph of FIG. 12. The distance L5 (17.5 μm or more and 19.5 μm or less) was 0.43×L2 or more and 0.4875×L2 or less in terms of the relationship with the length L2 of the diaphragm section 64 in the lateral direction. Thus, the distance L5 satisfied a numerical value range as described above, in the relationship with the length L2 and thereby it was possible to obtain the physical quantity sensor 1 having specifically good sensitivity.

Furthermore, the sensitivity when the distance L5 was 0 μm and the sensitivity when the distance L5 was 18.5 μm were calculated respectively based on the measured variation amount of the gap.

The sensitivity when the distance L5 was 0 μm was 8.49 ppm/kPa. Furthermore, the sensitivity when the distance L5 was 18.5 μm was 12.11 ppm/kPa. It was found that it is possible to improve the sensitivity of the physical quantity sensor 1 by biasing the functional element 7 to the side of the thick section 66 from the center O.

### 2. Pressure Sensor

Next, a pressure sensor (the pressure sensor according to the invention) including the physical quantity sensor according to the invention will be described. FIG. 13 is a cross-sectional view illustrating an example of the pressure sensor according to the invention.

As illustrated in FIG. 13, a pressure sensor 100 according to the invention includes the physical quantity sensor 1, a housing 101 storing the physical quantity sensor 1, and a calculating section 102 that calculates signals obtained from the physical quantity sensor 1 for pressure data. The physical quantity sensor 1 is electrically connected to the calculating section 102 through wiring 103.

The physical quantity sensor 1 is fixed on the inside of the housing 101 by a fixing unit (not illustrated). Furthermore, in the housing 101, the diaphragm section 64 of the physical quantity sensor 1 is provided with, for example, a through hole 104 communicating with the atmosphere (outside of the housing 101).

According to such a pressure sensor 100, the diaphragm section 64 receives the pressure through the through hole 104. The received signal is transmitted to the calculating section through the wiring 103 and is calculated for the pressure data. The calculated pressure data can be displayed through a display section (not illustrated) (for example, a monitor of a personal computer and the like).

### 3. Altimeter

Next, an example of an altimeter (the altimeter according to the invention) including the physical quantity sensor according to the invention will be described. FIG. 14 is a perspective view illustrating an example of the altimeter according to the invention.

An altimeter 200 can be worn on the wrist as a wristwatch. Furthermore, the physical quantity sensor 1 (pressure sensor 100) is built into the altimeter 200 and an altitude above sea level of a present location or an air pressure of the present location and the like can be displayed on a display section 201.

Moreover, various types of information such as a present time, a heart rate of a user, and the weather can be displayed in the display section 201.

### 4. Electronic Apparatus

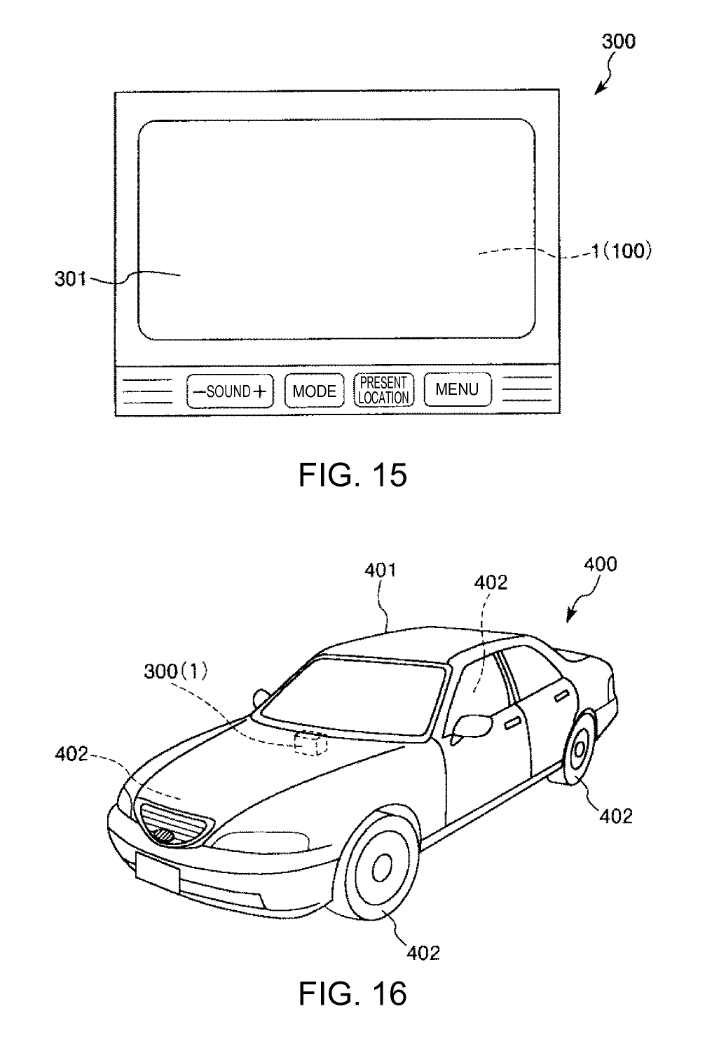

Next, a navigation system to which the electronic apparatus including the physical quantity sensor according to the invention is applied will be described. FIG. 15 is a front view illustrating an example of the electronic apparatus according to the invention.

A navigation system 300 includes a position information obtaining unit that obtains position information from map information (not illustrated) and a Global Positioning System (GPS), an autonomous navigation unit composed of a gyro sensor, an acceleration sensor, and vehicle speed data, the physical quantity sensor 1, and a display section 301 that displays predetermined position information or route information.

According to the navigation system, it is possible to obtain height information in addition to the obtained position information. By obtaining the height information, for example, when traveling on an elevated road of which substantially the same position is indicated as that of a general road in the position information, the navigation system cannot determine whether a vehicle travels on the general road or on the elevated road if the height information is not included so that the information of the general road is provided to a user as preferred information. Thus, in the navigation system 300 according to the embodiment, it is possible to obtain the height information by the physical quantity sensor 1 and a height change is detected due to entering the elevated road from the general road, and it is possible to provide the navigation information in the traveling state of the elevated road to the user.

Moreover, the display section 301 is configured to be compact and slim such as a liquid crystal panel display, or an Organic Electro-Luminescence (Organic EL) display.

Moreover, the electronic apparatus to which the physical quantity sensor according to the invention is incorporated is not limited to embodiments described above, and, for example, can be applied to a personal computer, a cellular phone, medical equipment (for example, an electronic thermometer, a blood pressure meter, a blood glucose meter, an electrocardiogram measuring device, an ultrasonic diagnostic apparatus, an electronic endoscope), various measuring equipment, instruments (for example, gauges for a vehicle, an aircraft and a ship), a flight simulator, and the like.

### 5. Moving Object

Next, a moving object (moving object according to the invention) to which the physical quantity sensor according to the invention is applied will be described. FIG. 16 is a perspective view illustrating an example of the moving object according to the invention.

As illustrated in FIG. 16, a moving object 400 has a vehicle body 401 and four wheels 402, and is configured to rotate the wheels 402 by a power source (engine) (not illustrated) provided in the vehicle body 401. The navigation system 300 (physical quantity sensor 1) is built into such a moving object 400.

As described above, the pressure sensor, the altimeter, the electronic apparatus, and the moving object according to the invention are described with reference to the illustrated embodiments, but the invention is not limited to the embodiments and the configuration of each part can be replaced by another arbitrary configuration matter having the same function. Furthermore, another arbitrary configuration matter or process may be added.

Furthermore, in the above embodiments, a case where the shape of the diaphragm section is rectangular in a plan view is described, but the shape is not specifically limited as long as the shape of the diaphragm section in a plan view is the longitudinal shape. For example, a polygonal shape such as hexagonal, a circular shape such as oval, and the like may be used. Furthermore, the polygonal shape includes one in which corners are rounded and outer edges are curved rather than straight. These configurations apply to the shape of the fixed electrode in a plan view.

Furthermore, in the above embodiments, a case where the shape of the movable electrode in a plan view is rectangular is described, but the shape of the movable electrode in a plan view is not specifically limited. For example, a polygonal shape such as square and hexagonal, a circular shape such as circular and oval, and the like may be used. Furthermore, the polygonal shape includes one in which the corners are rounded and the outer edges are curved rather than straight.

Moreover, in the first embodiment, a case where the end of the support section is disposed on the center of the diaphragm section is described, but the end of the support section may be provided in a position out of the center of the diaphragm section.

Furthermore, in the above embodiments, a case where the support section is provided in the diaphragm section or a case where the support section is provided over the diaphragm section and the thick section is described, but an entire region of the support section may be provided in the thick section.

Furthermore, in the above embodiments, a case where the area of the fixed electrode in a plan view is greater than that of the movable section of the movable electrode is described, but the area of the fixed electrode in a plan view may be equal to that of the movable section of the movable electrode and may be smaller than that of the movable section of the movable electrode.

The entire disclosure of Japanese Patent Application No. 2013-205752, filed Sep. 30, 2013 is expressly incorporated by reference herein.

What is claimed is:

1. A physical quantity sensor comprising:
a diaphragm section that is deformed to be deflected by receiving a pressure;
a fixed electrode that is provided in the diaphragm section; and
a movable electrode that has a movable section that is away from the fixed electrode and is disposed opposite to the fixed electrode,
wherein a shape of the diaphragm section in a plan view is a longitudinal shape, and
wherein a shape of the fixed electrode in a plan view is a longitudinal shape extending along a longitudinal direction of the diaphragm section.

2. The physical quantity sensor according to claim 1,
wherein the movable electrode has a support section that is provided in the diaphragm and a connection section that connects the support section and the movable section.

3. The physical quantity sensor according to claim 2,
wherein the fixed electrode and the support section are arranged along a lateral direction of the diaphragm section.

4. The physical quantity sensor according to claim 3,
wherein the lateral direction of the fixed electrode and the lateral direction of the diaphragm section are the same as each other.

5. The physical quantity sensor according to claim 1,
wherein the shape of the diaphragm section in a plan view is configured such that L2/L1 is within a range of 1.5 or more and 3.0 or less when a length in the longitudinal direction is L1 and a length in the lateral direction is L2.

6. A pressure sensor comprising:
the physical quantity sensor according to claim 1.

7. An altimeter comprising:
the physical quantity sensor according to claim 1.

8. An electronic apparatus comprising:
the physical quantity sensor according to claim 1.

9. A moving object comprising:
the physical quantity sensor according to claim 1.
